(19) United States
(12) Patent Application Publication
(10) Pub. No.: US 2024/0111355 A1
(43) Pub. Date: Apr. 4, 2024

(54) INCREASING SYSTEM POWER EFFICIENCY BY OPTICAL COMPUTING

(71) Applicant: Advanced Micro Devices, Inc., Santa Clara, CA (US)

(72) Inventors: Sergey Blagodurov, Bellevue, WA (US); Kevin Y. Cheng, Bellevue, WA (US); SeyedMohammad SeyedzadehDelcheh, Bellevue, WA (US); Masab Ahmad, Austin, TX (US)

(73) Assignee: Advanced Micro Devices, Inc., Santa Clara, CA (US)

(21) Appl. No.: 17/956,606

(22) Filed: Sep. 29, 2022

(51) Int. Cl. G06F 1/329

(52) U.S. Cl. CPC G06F 1/329

(57) ABSTRACT

Methods and systems are disclosed for reducing power consumption by a system including a digital unit and an optical unit. Techniques disclosed comprise generating a workload signature of an incoming workload to be executed by the system. Based on the generated workload signature, techniques disclosed comprise matching the incoming workload with a profile of stored workload profiles. The workload profiles are generated by a trace capture unit. Based on the associated profile, a task submission transaction is sent to the optical unit of the system, representative of a request to execute the incoming workload by the optical unit.

### BACKGROUND

Data-center chips process data-intensive workloads, running artificial intelligence (AI) algorithms, for example. Such chips often consume large amount of power, reaching their thermal limits. Consequently, in some data-centers, the risk of chips reaching their thermal limits constrains the number of chip cards that can be placed within a certain space (e.g. a rack unit). This is especially an issue because today's integrated circuits contain a large number of transistors, a number that doubles with each new chip technology generation. Given a thermal design power (TDP) constraint, all these transistors cannot be powered simultaneously (the so-called dark silicon challenge where only a percentage of the silicon space can be used simultaneously). And so, circuit designers face the challenging task of leveraging the silicon space in the most efficient manner given a TDP constraint.

To address thermal limitations in system design, optical computing units are proposed that apply silicon photonics to process data-intensive workloads. Optical (or photonic-based) computing allows for scaling up performance efficiency without a significant increase in power dissipation. Thus, for example, a deep neural network (DNN) may be scaled up (using a deeper neural network) without being limited by power dissipation. Additionally, optical computing has a unique benefit over digital (or transistor-based) computing, as it allows for scaling via wavelength-division multiplexing (WDM), where multiple operations can be employed simultaneously at different respective light wavelengths using the same computing arrays. Hence, system and methods are needed that enhance the performance of digital systems by optical computing, drawing on the benefits of optical computing technologies.

### BRIEF DESCRIPTION OF THE DRAWINGS

A more detailed understanding may be had from the following description, given by way of example in conjunction with the accompanying drawings wherein:

FIG. 1 is a block diagram of an example system, based on which one or more features of the disclosure can be implemented;

FIG. 2 is a block diagram of an example photonic-enabled system, based on which one or more features of the disclosure can be implemented;

FIG. 3 is a block diagram of an example trace capture system, based on which one or more features of the disclosure can be implemented;

FIG. 4 is a flowchart of an example method for selecting between a digital execution path and an optical execution path, based on which one or more features of the disclosure can be implemented;

FIG. 5 is a flowchart of an example method for efficient signal conversions, based on which one or more features of the disclosure can be implemented;

FIG. 6 is a flowchart of an example method for reducing power consumption by convertors of an optical unit, based on which one or more features of the disclosure can be implemented; and

FIG. 7 is a flowchart of an example method for reducing power consumption by a photonic-enabled system, based on which one or more features of the disclosure can be implemented.

### DETAILED DESCRIPTION

Digital computing and optical computing technologies can be advantageously combined into photonic-enabled systems, getting the best of each technology. A system that is capable of performing workloads in both digital and optical domains is disclosed herein. The domain employed to execute a workload can be determined based on a comparison between performance measures associated with the execution of the workload in the digital domain and performance measures associated with the execution of the workload in the optical domain. A workload profile, including the workload's signature and the performance measures, is extracted by a trace capture unit disclosed herein. Thus, a workload may be assigned to the optical domain if, based on the workload profile, the optical domain outperforms the digital domain with respect to that workload.

Hence, system power consumption can be improved by selectively scheduling computational tasks in one of digital or optical units. For example, in the case of DNN workloads, functions such as linearization, scaling, pooling, and activation may be better suited for a transistor-based circuitry (in a digital domain), while other functions, such as convolutions or other vector operations, may be better suited for a photonic-based circuitry (in an optical domain). Although certain functions may be better suited for a photonic-based circuitry, overhead power consumption by the convertors of the optical unit—that is, the digital-to-analog convertor (DAC) and the analog-to-digital convertor (ADC)—has to be taken into consideration too. However, such overhead can be reduced by increasing the operational efficiency of the convertors, as disclosed herein.

Aspects of the present disclosure disclose methods for reducing power consumption by a system including a digital unit and an optical unit. The methods include generating a workload signature of an incoming workload. Based on the signature, associating the incoming workload with a profile of workload profiles. And, then, based on the associated profile, sending a task submission transaction to the optical unit. The task submission transaction is representative of a request to execute the incoming workload.

Aspects of the present disclosure also disclose systems, including a digital unit and an optical unit, for reducing power consumption. The systems include at least one processor and memory storing instructions. The instructions, when executed by the at least one processor, cause the systems to generate a signature of an incoming workload, to associate the incoming workload, based on the signature, with a profile of workload profiles, and to send, based on the associated profile, a task submission transaction to the optical unit. The task submission transaction is representative of a request to execute the incoming workload.

Furthermore, aspects of the present disclosure disclose a non-transitory computer-readable medium comprising instructions executable by at least one processor to perform methods for reducing power consumption by a system including a digital unit and an optical unit. The methods include generating a signature of an incoming workload. Based on the signature, associating the incoming workload with a profile of workload profiles. And, then, based on the associated profile, sending a task submission transaction to the optical unit. The task submission transaction is representative of a request to execute the incoming workload.

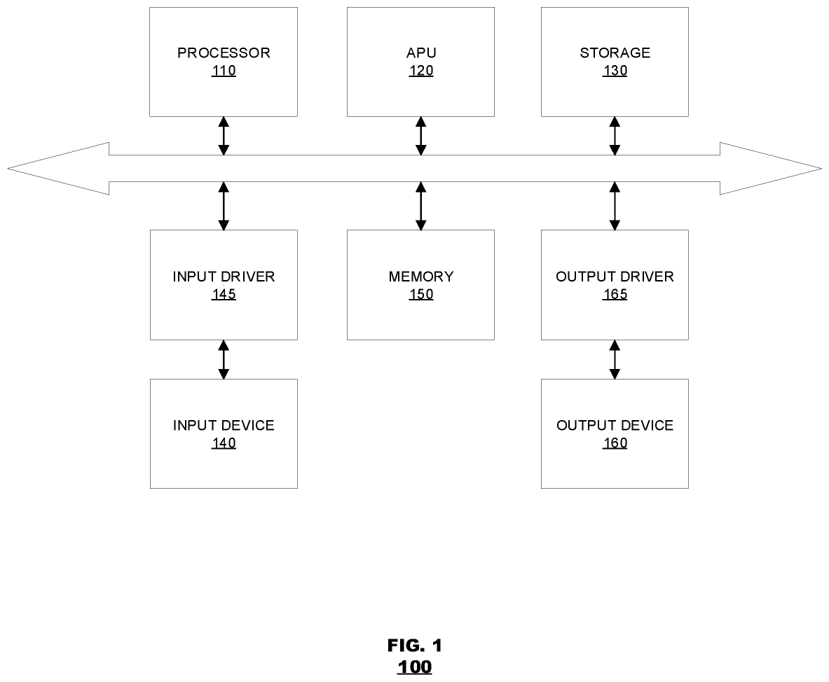

FIG. 1 is a block diagram of an example system 100, based on which one or more features of the disclosure can be implemented. The system 100 can be, for example, a computer, a gaming device, a handheld device, a set-top box, a television, a mobile phone, or a tablet computer. The system 100 can include a processor 110, an accelerated processing unit (APU) 120, storage 130, an input device 140, memory 150, and an output device 160. The system 100 can also include an input driver 145 and an output driver 165. The processor 110 and the APU 120 can represent one or more cores of central processing units (CPUs) and one or more cores of APUs, respectively. The memory 150 can represent volatile or non-volatile memory, including random-access memory (RAM), SRAM, dynamic random-access (DRAM), a cache, or a combination thereof. The processor 110, the APU 120, and the memory 150, or a subset thereof, may be located on the same die or on separate dies. In an aspect, the system 100 can include additional components not shown in FIG. 1.

The APU 120 can represent a graphics processing unit (GPU), that is, a shader system comprising one or more parallel processing units that are configured to perform computations, for example, in accordance with a single instruction multiple data (SIMD) paradigm. The APU 120 can be configured to accept compute commands and graphics rendering commands from the processor 110, to process those compute and graphics rendering commands, and/or to provide output to a display (the output device 160).

The storage 130 can include fixed or removable storage, for example, a hard disk drive, a solid-state drive, an optical disk, or a flash drive. The input device 140 can represent, for example, a keyboard, a keypad, a touch screen, a touch pad, a detector, a microphone, an accelerometer, a gyroscope, a biometric scanner, or a network connection (e.g., a wireless local area network card for receipt of wireless IEEE 802 signals). The output device 160 can represent, for example, a display, a speaker, a printer, a haptic feedback device, one or more lights, an antenna, or a network connection (e.g., a wireless local area network card for transmission of wireless IEEE 802 signals). In an aspect, the input driver 145 communicates with the processor 110 (or the APU 120) and the input device 140, and facilitates the receiving of input from the input device 140 to the processor 110 (or the APU 120). In another aspect, the output driver 165 communicates with the processor 110 (or the APU 120) and the output device 160, and facilitates the sending of output from the processor 110 (or the APU 120) to the output device 160.

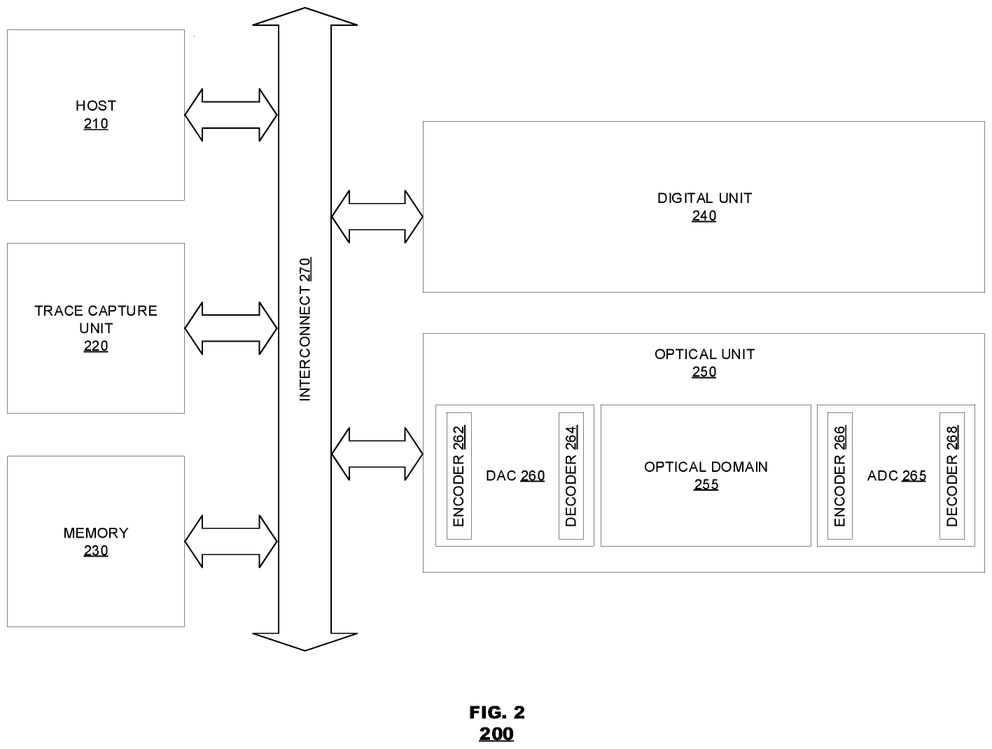

A hybrid computing system is disclosed herein, including a digital unit and an optical unit, each capable of performing workloads (e.g., AI computational tasks) within its respective digital or optical domain. Having an alternative computing domain (that is, the optical domain) allows for reducing the number of transistors in the digital unit that are simultaneously powered. The system is configured to determine whether a workload is to be executed by the digital unit or by the optical unit based on the workload profile, including the workload signature and domain-based performance measures, as further explained in reference to FIG. 2-4.

FIG. 2 is a block diagram of an example photonic-enabled system 200, based on which one or more features of the disclosure can be implemented. The system 200 includes a host 210 (e.g., the processor 110 of FIG. 1), memory 230 (e.g., the memory 150 of FIG. 1), and a digital unit 240 (e.g., the APU 120 of FIG. 1). The system 200 further includes an optical unit 250. The optical unit 250 converts digital data input into analog data, via a DAC 260. Then, the optical unit 250 processes the analog data in its optical domain 255, before converting the analog data output (that is, the processing results) into digital data, via an ADC 265. Typically, the optical domain 255 contains one or more laser components, one or more photonic arrays, and any other components that may facilitate computations in this domain. The system 200 also includes a trace capture unit 220, the functions of which can be implemented by software, firmware, or hardware. For example, the trace capture unit 220 can be an application-specific integrated circuit (ASIC) controller or a general-purpose micro-controller. The system's 200 components 210, 220, 230, 240, 250 are communicatively connected via an interconnect 270. The interconnect 270 can be a bus system that facilitates connection via switchers (not shown) to the components of the system 200.

The trace capture unit 220 is configured to monitor transactions, traveling via the interconnect 270, that are associated with the digital 240 and the optical 250 units. In an aspect, the trace capture unit 220 forms a non-invasive extension to bridges that connect the host 210 to the digital unit 240 and to the optical unit 250. To that end, the trace capture unit 220 can be placed on northbridges (not shown) of the interconnect 270 and be configured to snoop data packets that enter and exit the computational units 240, 250. In doing so, the trace capture unit 220 can capture information associated with workloads (computational tasks or kernels) that are scheduled for execution in the computational units 240, 250.

Hence, the trace capture unit 220 looks for transactions that contain information regarding computational tasks that are scheduled (e.g., assigned by the host 210) to be executed by the computational units 240, 250 and for transactions that contain information regarding the completion of these scheduled computational tasks. For example, the trace capture unit 220 can monitor transactions that are directed to the input queue of a computational unit 240, 250, namely, task submission transactions. These transactions are typically associated with computational tasks (workloads) that are scheduled for execution in the computational unit 240, 250. The trace capture unit 220, can then extract characteristic information from each transaction, such as the transaction timestamp, transaction length, transaction instruction type, transaction address, and transaction payload. This information can be used to form a signature for the respective workload based on which the workload can be recognized in future scheduling—the signature may include the kernel's name, arguments, binary code, or operated upon data, for example. Furthermore, the trace capture unit 220 can look for transactions that originate from the output queue of a computational unit 240, 250 namely, task completion transactions. These transactions indicate completion of respective computational tasks (containing the computational tasks' results). Based on these transactions' timestamps, the trace capture unit 220, can compute the execution time and the power consumed by the task, taking under consideration whether the respective transaction originated from the output queue of the digital or the optical unit.

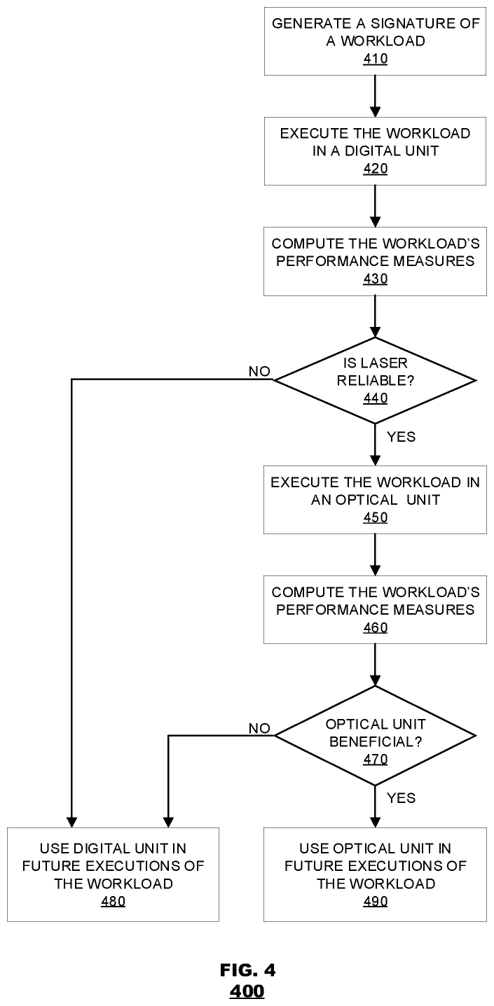

For example, monitoring a task submission transaction that was sent into the input queue of the digital unit 240 (associated with the scheduling of a task to be executed) and a respective task completion transaction that was sent out of the output queue of the digital unit 240 (associated with a completion of that task) allows for the profiling of that task with respect to the digital unit. Likewise, monitoring a transaction associated with the same task that was sent to the input queue of the optical unit 250 and a transaction associated with the completion of that task that was sent out of the output queue of the optical unit 250 allows for the further profiling of that task with respect to the optical unit. Such a profile can include a signature of the task (by which the task can be recognized) and performance measures with respect to each of the digital 240 and optical 250 units. The performance measures can include the task's execution time and the power consumed by the execution of the task in each of the optical and the digital units. The trace capture unit 220 can record the profile of the task and can use it in future deployments of that task to determine which unit 240, 250 should be used for its execution, as further explained, in reference to FIG. 4

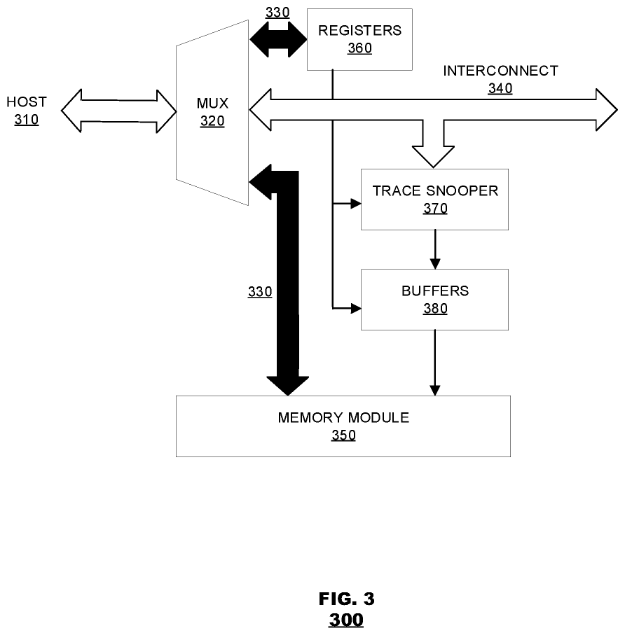

FIG. 3 is a block diagram of an example trace capture system 300, based on which one or more features of the disclosure can be implemented. The trace capture system 300 provides architectural detail to the trace capture unit 220 shown in FIG. 2. As illustrated, the system 300 includes a multiplexer (MUX) 320, registers 360, a trace snooper 370, buffers 380, and a memory module 350. The memory module may be local to the trace capture system 300 or external to it (e.g., the memory 230 of FIG. 2). As mentioned above, the functions of the system 300 can be implemented by software, firmware, or hardware, and can be implemented by an application-specific integrated circuit (ASIC) controller or a general-purpose micro-controller.

The registers 360 can be used to store operational status data and control data. Having access 330 to these registers 360, the host 310 can control the operation of the trace capture system 300 via control data it can write into these registers. The host can get updates regarding the state of the trace capture system 300 via status data it can read from these registers. In this manner, the host can configure and enable the operation of the system 300, including the operation of the trace snooper 370. The buffers 380 are configured to receive data (e.g., workloads profiles) generated by the trace snooper 370 and submit the buffered data to memory via a memory controller (not shown) that interfaces with the memory module 350.

The trace snooper 370 is configured to extract information from transactions traveling through the interconnect 340, 270. The trace snooper 370 employs a snooping mechanism that contains a reconfigurable switch fabric, configured by data stored in the registers 360. Thus, through data stored in the registers 360, the host 310 can dynamically determine what information is collected by the trace snooper 370 from transactions traveling through the interconnect 340, 270. In an aspect, the trace snooper 370 may be configured to intercept certain transactions, that is, task submission transactions (transactions that are sent to an input queue of a computing unit 240, 250 for execution) and task completion transactions (transactions that are sent out of an output queue of a computing unit 240, 250 containing the computation results associated with respective task submission transactions). The trace snooper 370 may be further configured to collect information from those transactions, such as a transaction timestamp, transaction length, transaction instruction type, transaction address, and transaction payload. Out of information collected from task submission transactions and corresponding task completion transactions, the trace snooper 370 can generate a profile for a respective workload (a “workload profile”), including a signature by which the workload can be identified as well as performance measures that are associated with performing the workload in the digital and the optical units.

The multiplexer 320 is configured to provide the host 310, 210, with direct access 330 to components of the trace capture system 300, such as the registers 360 and the memory module 350. The multiplexer establishes a connection between the host and a component of the system 300 based on an address provided in a host request. Thus, when the address in a host request is mapped into a physical address of a component of the trace capture system 300, that request will not be seen by the interconnect 340, 270, and, therefore, will be transparent to it. In this way, the trace capture system 300 can be controlled by the host 310 in a non-invasive manner, that is, without affecting communication performance on the interconnect 340, 270. Through this access 330, facilitated by the multiplexer 320, the host can read status data about the operation of the trace capture system 300 and can write control data to control its 300 operation. Further, through this access the host can read from the memory module 350 workload profiles generated based on data traced by the trace snooper 370. The host can use the read profiles for diagnostics, for example. Further, the host can populate the memory module 350 with already generated workload profiles, saving the trace snooper 370 the need to dynamically generate such profiles.

FIG. 4 is a flowchart of an example method 400 for selecting between a digital execution path and an optical execution path, based on which one or more features of the disclosure can be implemented. Method 400 begins, in step 410, by generating a workload signature, by which the workload can be identified in future executions of the workload. The method 400 proceeds, in step 420, by executing the workload in a digital unit 240. Then, in step 430, performance measures are computed, measuring the execution performance of the workload in the digital unit. Next, the method 400 can check whether a laser of the optical unit 250 is reliable (operational) in step 440. For example, the laser reliability may be determined based on whether the count in past laser activations exceeds a predetermined threshold or based on the number of times the laser miss-fired. If the laser is found to be sufficiently reliable for use with the photonics arrays of the optical unit 250, the method 400 proceeds by executing the workload in the optical unit 250 in step 450. Then, in step 460, performance measures are computed, measuring the execution performance of the workload in the optical unit. The performance measures, computed in steps 430 and 460, include, for example, the level of power consumed during the execution of the workload and the workload execution time (or latency). In step 470, if the performance measures, as computed with respect to the workload executions in the digital unit 240 and the optical unit 250, suggest that the optical unit outperforms the digital unit, the optical unit will be deployed next time the workload has to be executed 490, during which time the digital execution path may be turned off. Otherwise, if the performance measures suggest that the optical unit does not outperform the digital unit, or if the laser was not found to be reliable, the digital unit will be deployed next time the workload has to be executed 480, during which time the optical execution path may be turned off.

To determine based on the performance measures whether the optical unit outperforms the digital unit, in an aspect, the following cost metrics may be computed:

Mₒ=α·Pₒ+β·Tₒ, (1)

M_{d}=γ·P_{d}+δ·T_{d}, (2)

where Pₒ and P_{d} denote the levels of power consumed during the workload execution by the optical and the digital units, respectively, and where Tₒ and T_{d} denote the execution times of the workload in the optical and the digital units, respectively. Weights α, β, γ, and δ may be used to balance the level of power consumed against the execution time. For example, based on a preference of the application associated with the workload, the weights may be set to α=β=γ=δ=1. Thus, if the cost metrics computed for a workload result in Mₒ<M_{d}, it can be concluded that the optical unit 250 outperforms the digital unit 240 with respect to that workload, and, so, the optical unit will be deployed the next time that that workload is to be execute.

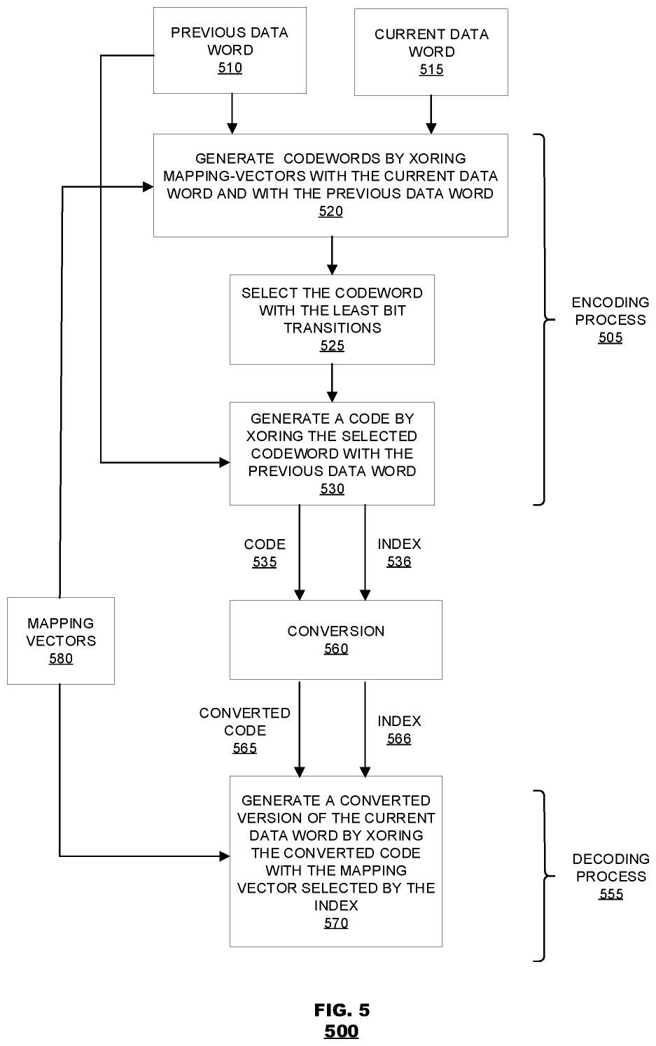

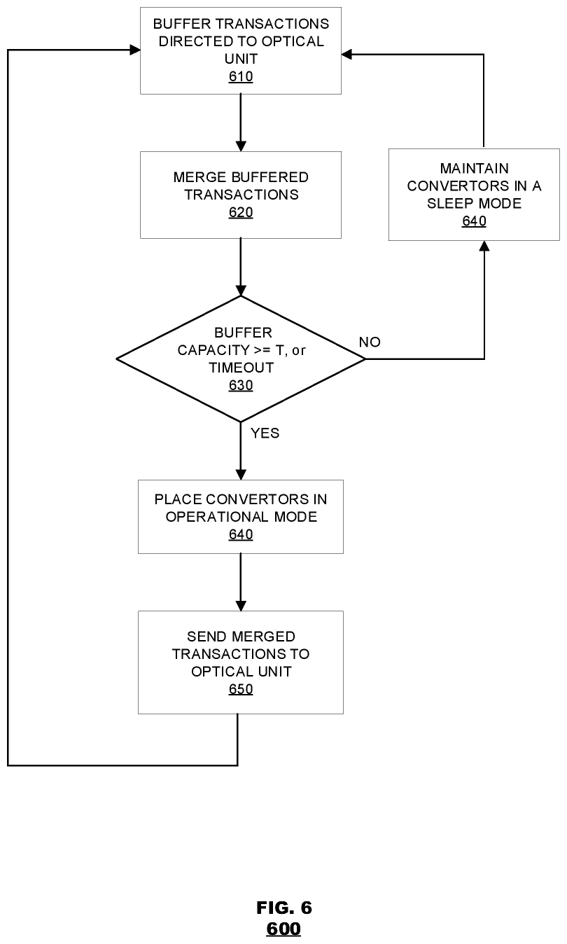

In an aspect, the level of power consumed by the convertors 260, 265 can be reduced, thereby, reducing Pₒ, the level of power consumed by the optical unit 250 to execute a workload. In state-of-the-art systems, the DAC 260 and ADC 265 may consume twice the power consumed by components of the optical domain 255, and, so, efficient usage of the convertors may render the optical unit 250 even more power-competitive relative to the digital unit 240. Techniques for improving the usage efficiency of the convertors are described herein in reference to FIG. 5 and FIG. 6.

The DAC 260 and the ADC 265 of the optical unit 250 can operate more efficiently when consecutive data words they convert contain the least number of transitions across corresponding bits. Accordingly, before data words, in their digital form, are served to the DAC 260 to be converted into their analog form, a digital encoder 262 encodes these data words into a code sequence with least bit transitions. Then, after the conversion 260 of that code sequence into its analog form, an analog decoder 264 extracts from the converted code sequence an analog form of the data words. Likewise, before data words, in their analog form, are served to the ADC 265 to be converted into their digital form, an analog encoder 266 encodes these data words into a code sequence with least bit transitions. Then, after the conversion of that code sequence into its digital form, a digital decoder 268 extracts from the converted code sequence a digital form of the data words. The encoding 262, 266, and decoding 264, 268 operations are further described with respect to FIG. 5.

FIG. 5 is a flowchart of an example method 500 for efficient signal conversions, based on which one or more features of the disclosure can be implemented. The method 500 involves encoding 505 successive data words 510, 515, serving the coded data words (namely, code sequence) to a convertor to be converted (either the DAC 260 or the ADC 265), and extracting converted data words by decoding 555 the converted coded data words (that is, the converted code sequence), as further described below.

Method 500 encodes 505 a current data word 515, D_{curr}, relative to a previous data word 510, Dₚᵣₑᵥ, resulting in a code C_{curr}. The goal is to minimize the bit transitions between successive codes Cₚᵣₑᵥ and C_{curr}. The Method 500 begins, in step 520, where M number of codewords, CW, are generated as follows:

CW(i)=MV(i)×D_{curr}×Dₚᵣₑᵥ, (3)

where, MV(i) denotes a mapping vector and i is an index that selects a mapping vector out of M mapping vectors 580. The operator × denotes a bitwise XOR operation. The method 500 proceeds, is step 525, by selecting a codeword CW(i=n) (out of the M codewords) with the least bit transitions when compared with the current data word D_{curr} and previous data word Dₚᵣₑᵥ. Based on the selected codeword, a code, C_{curr}, is generated, in step 530, as follows:

C_{curr}=CW(n)×Dₚᵣₑᵥ, (4)

where, × denotes a bitwise XOR operation between the selected codeword CW(n) and the previous data word Dₚᵣₑᵥ.

Hence, instead of converting the data word 515, D_{curr}, the convertor (either the DAC 260 or the ADC 265) converts 560 the corresponding code C_{curr} 535. The converted code 565, denoted Ĉ_{curr}, is next decoded 555, in step 570, to extract a converted version of the current data word D_{curr} 515, as follows:

\hat{D}_{curr}=Ĉ_{curr}×CW(n), (5)

where, × denotes a bitwise XOR operation between the selected codeword CW(n) and the converted code Ĉ_{curr}, resulting in the converted current data word \hat{D}_{curr}. Notice that this approach 500 has an overhead associated with the index data 536, 566, as the log₂(M) bits of the index data have to be stored and processed by the convertor 260, 265 to facilitate the decoding 555. Moreover, the mapping vectors 580 has to be accessible to the encoder 505 and the decoder 555, for example, using a local memory (e.g., Read only Memory (ROM)) in the convertor 260, 265 that is cheap in terms of power and energy.

By applying conversion 560 to successive codes, Cₚᵣₑᵥ and C_{curr}, that contain the least number of transitions across corresponding bits (relative to successive data words, Dₚᵣₑᵥ and D_{curr}), the number of times the convertor has to perform conversions is reduced, and, consequently, less power is consumed by the respective circuitry of the convertor. Note that when the method 500 is used by the DAC 260, the encoding 505 is applied by a digital encoder 262 and the decoding 555 is applied by an analog decoder 264. On the other hand, when the method 500 is used by the ADC 265, the encoding 505 is applied by an analog encoder 266 and the decoding 555 is applied by a digital decoder 268.

In another aspect, the operational efficiency of the convertors 260, 265 can be improved by increasing the time the convertors can be placed in a sleeping mode (switched off), thereby, further reducing the power consumption of the optical unit 250. To that end, transactions that are directed at the optical unit may be merged over time and sent together to the optical unit 250. In this manner, the time durations through which analog components in the converters can be turned off or put in a sleep mode can be increased.

FIG. 6 is a flowchart of an example method 600 for reducing power consumption by convertors of an optical unit, based on which one or more features of the disclosure can be implemented. In an aspect, method 600 may be employed by the host 210. The method 600 begins, in step 610, by buffering one or more transactions that are directed to the optical unit 250. For example, the host 210 may buffer such transactions in memory 230. The buffered transactions can then be merged into one or more transactions, in step 620. Merging transactions can be performed based on adjacency (or similarity) among the transactions. Then, in step 630, it is determined whether the buffer reached a percentage of (or a predetermined threshold relative to) its maximum capacity or if a predetermined time (timeout) has expired. If the condition of step 630 has not been satisfied, the convertors can be maintained in a sleep mode, in step 640, and the buffering of incoming transactions continues in step 610. If the condition of step 630 has been satisfied, the convertors are placed in operational mode in step 640. And, in step 650, the merged transactions are sent to the optical unit 250. Employing method 600, the optical unit 250 and its convertors deal with merged transactions rather than single transactions. In this way, the optical unit 250 and its convertors 260, 265 can be placed in a sleep mode for longer time durations and hence power consumption is reduced.

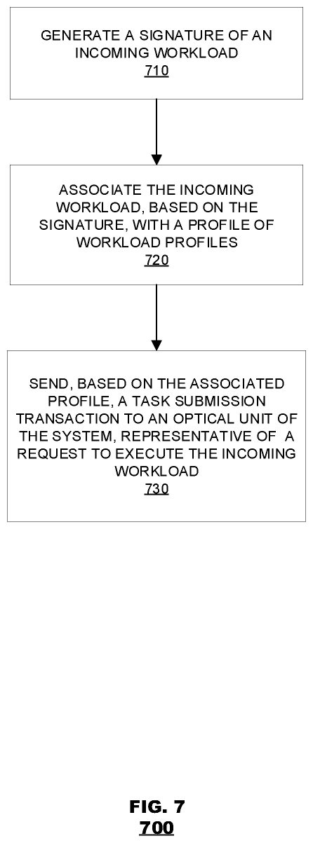

FIG. 7 is a flowchart of an example method 700 for reducing power consumption by a photonic-enabled system 200, based on which one or more features of the disclosure can be implemented. The method 700 begins, in step 710, by generating a signature of an incoming workload that is to be executed by either the digital unit 240 or the optical unit 250 of the system 200. Based on the signature, in step 720, the incoming workload is associated with a profile out of workload profiles. In this situation, the trace capture unit 220 has already generated a workload profile that has a signature that matches the signature of the incoming workload. Thus, the incoming workload is able to be associated with an already stored profile of the workload profiles that were generated and stored by the trace capture unit 220. Then, based on the associated profile, a task submission transaction is sent to the optical unit 250, representative of a request to execute the incoming workload by the optical unit. More specifically, in this instance, the associated profile indicates that the workload is deemed to be more advantageously executed on the optical unit 240 as compared with the digital unit 240. For this reason, the task submission transaction is sent to the optical unit 250 for execution.

The workload profiles can be generated by the trace capture unit 220, as described above. Each profile of the workload profiles is associated with a workload and includes that workload's signature and domain-based performance measures—that is, some of the performance measures are associated with executing the workload in the digital unit 240, and some of the performance measures are associated with executing the workload in the optical unit 250. In an aspect, a performance measure can be a level of power consumed by the execution of the workload in a respective domain (digital or optical) or an execution time of that workload in the respective domain. Hence, sending a task submission transaction to the optical unit (in step 730) may include scheduling the incoming workload to be executed in the optical unit, if based on the associated profile (step 720) the performance measures associated with the optical domain 250 outperforms the performance measures associated with the digit al domain 240.

It should be understood that many variations are possible based on the disclosure herein. Although features and elements are described above in particular combinations, each feature or element can be used alone without the other features and elements or in various combinations with or without other features and elements.

The methods provided can be implemented in a general-purpose computer, a processor, or a processor core. Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such as instructions capable of being stored on a computer readable media). The results of such processing can be maskworks that are then used in semiconductor manufacturing processes to manufacture processors that implement aspects of the embodiments.

The methods or flowcharts provided herein can be implemented in a computer program, software, or firmware incorporated in a non-transitory computer-readable storage medium for execution by a general-purpose computer or processor. Examples of non-transitory computer-readable media include read only memory (ROM), random-access memory (RAM), a register, cache memory, semiconductor memory devices, magnetic media such as internal hard drive and disks and removable disks, magneto-optical media, and optical media such as CD-ROM disks, and digital versatile disks (DVDs).

What is claimed is:

1. A method for reducing power consumption by a system including a digital unit and an optical unit, comprising:
generating a workload signature of an incoming workload;
matching the incoming workload, based on the workload signature, with a workload profile of stored workload profiles; and
sending, based on the associated profile, a task submission transaction to the optical unit, representative of a request to execute the incoming workload.

2. The method of claim 1, wherein the profile comprises:
the workload signature;
a first set of performance measures associated with executing the workload in the digital unit; and
a second set of performance measures associated with executing the workload in the optical unit.

3. The method of claim 2, wherein a performance measure, of the first set or the second set, is a level of power consumed by the execution of the workload or an execution time of the workload.

4. The method of claim 2, wherein the sending, comprises:
scheduling the incoming workload to be executed in the optical unit responsive to a second set of performance measures of the associated profile indicated as outperforming the first set of performance measures of the associated profile.

5. The method of claim 2, further comprising:
generating the workload signature of the profile by:
monitoring, by a trace capture unit of the system, transactions, including a task submission transaction associated with the workload;
extracting information out of the transactions, the extracted information is characteristic of the workload; and
generating, based on the extracted information, the workload signature.

6. The method of claim 2, further comprising:
generating the first set of performance measures of the profile by:
monitoring, by the trace capture unit, a first group of transactions associated with the workload, including a task submission transaction and a respective task completion transaction that are directed at the digital unit of the system; and
computing, based on information extracted from the first group of transactions, the first set of performance measures.

7. The method of claim 2, further comprising:
generating the second set of performance measures of the profile by:
monitoring, by the trace capture unit, a second group of transactions associated with the workload, including a task submission transaction and a respective task completion transaction that are directed at the optical unit; and
computing, based on information extracted from the second group of transactions, the second set of performance measures.

8. The method of claim 1, further comprising:
encoding a data word sequence fed to a convertor of the optical unit, wherein the encoding reduces the number of transitions across corresponding bits in successive data words of the data word sequence; and
converting the encoded data word sequence by the convertor,
wherein when the convertor is a digital-to-analog convertor the encoding is by a digital encoder and when the convertor is an analog-to-digital convertor the encoding is by an analog encoder.

9. The method of claim 1, further comprising:
generating signatures of respective incoming workloads;
associating the incoming workloads, based on the signatures, with respective profiles of workload profiles;
buffering task submission transactions, each of the transactions represents a request to execute a respective workload of the incoming workloads;
merging the buffered task submission transactions into a merged task submission transaction; and
sending the merged task submission transaction to the optical unit.

10. The method of claim 1, wherein:
before the sending, transitioning a convertor of the optical unit from a sleep mode into an operational mode.

11. A system, including a digital unit and an optical unit, for reducing power consumption, comprising:
at least one processor; and
memory storing instructions that, when executed by the at least one processor, cause the system to:
generate a workload signature of an incoming workload,
match the incoming workload, based on the workload signature, with a workload profile of stored workload profiles, and
send, based on the associated profile, a task submission transaction to the optical unit, representative of a request to execute the incoming workload.

12. The system of claim 11, wherein the profile comprises:
the workload signature;
a first set of performance measures associated with executing the workload in the digital unit; and
a second set of performance measures associated with executing the workload in the optical unit.

13. The system of claim 12, wherein a performance measure, of the first set or the second set, is a level of power consumed by the execution of the workload or an execution time of the workload.

14. The system of claim 12, wherein the sending, comprises:
scheduling the incoming workload to be executed in the optical unit responsive to a second set of performance measures of the associated profile indicated as outperforming the first set of performance measures of the associated profile.

15. The system of claim 12, wherein the instructions further cause the system to:
generate the workload signature of the profile by:
monitoring, by a trace capture unit of the system, transactions, including a task submission transaction associated with the workload;
extracting information out of the transactions, the extracted information is characteristic of the workload; and
generating, based on the extracted information, the workload signature.

16. The system of claim 12, wherein the instructions further cause the system to:
generate the first set of performance measures of the profile by:
monitoring, by the trace capture unit, a first group of transactions associated with the workload, including a task submission transaction and a respective task completion transaction that are directed at the digital unit of the system; and
computing, based on information extracted from the first group of transactions, the first set of performance measures.

17. The system of claim 12, wherein the instructions further cause the system to:
generate the second set of performance measures of the profile by:
monitoring, by the trace capture unit, a second group of transactions associated with the workload, including a task submission transaction and a respective task completion transaction that are directed at the optical unit; and
computing, based on information extracted from the second group of transactions, the second set of performance measures.

18. The system of claim 11, wherein the instructions further cause the system to:
encode a data word sequence fed to a convertor of the optical unit, wherein the encoding reduces the number of transitions across corresponding bits in successive data words of the data word sequence; and
converting the encoded data word sequence by the convertor,
wherein when the convertor is a digital-to-analog convertor the encoding is by a digital encoder and when the convertor is an analog-to-digital convertor the encoding is by an analog encoder.

19. The system of claim 11, wherein the instructions further cause the system to:
generate signatures of respective incoming workloads;
associate the incoming workloads, based on the signatures, with respective profiles of workload profiles;
buffer task submission transactions, each of the transactions represents a request to execute a respective workload of the incoming workloads;
merge the buffered task submission transactions into a merged task submission transaction; and
send the merged task submission transaction to the optical unit, wherein before the sending, a convertor of the optical unit is transitioned from a sleep mode into an operational mode.

20. A non-transitory computer-readable medium comprising instructions executable by at least one processor to perform a method for reducing power consumption by a system including a digital unit and an optical unit, the method comprising:
generating a workload signature of an incoming workload;
matching the incoming workload, based on the workload signature, with a workload profile of stored workload profiles; and
sending, based on the associated profile, a task submission transaction to the optical unit, representative of a request to execute the incoming workload.
